(19) United States
(12) Patent Application Publication
(10) Pub. No.: US 2021/0357874 A1
(43) Pub. Date: Nov. 18, 2021

(54) METHOD AND SYSTEM FOR INTELLIGENT CALENDERING OF EVENTS

(71) Applicant: Orcatec LLC, Rancho Santa Fe, CA (US)

(72) Inventor: Alexei Golopapenko, Rancho Santa Fe, CA (US)

(21) Appl. No.: 16/876,986

(22) Filed: May 18, 2020

(51) Int. Cl. G06Q 10/10; H04L 29/06; G06F 16/23; G09G 5/02; G09G 5/373

(52) U.S. Cl. CPC G06Q 10/1093; H04L 63/08; G06F 16/2336; G09G 2320/0666; G09G 5/373; G09G 2354/00; G09G 2340/04; G09G 5/02

(57) ABSTRACT

A system for calendaring an event for a first user in a calendar matrix. The system comprises a hardware processor configured to authenticate a first user for accessing the calendar matrix, which comprises at least one event calendared for a second user. The hardware processor is further configured to allow the first user to enter the event for the first user into the calendar matrix. The system further comprises a memory device in communication with the hardware processor and configured to store the calendar matrix for later retrieval by the hardware processor. The hardware processor is further configured to adjust display dimensions of a rectangle representing the entered event in the calendar matrix to the first user based on projected duration of the event and independent of timeslot durations in the calendar matrix. The hardware processor is further configured to prohibit an overlap between two or more appointment events.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

This disclosure relates to a calendaring and/or scheduling system over a communications network.

Description of the Related Art

Electronic transactions between users and recipients over the Internet and similar communications network have increased significantly in recent years. Contractors now transact business with their clients, such as scheduling, billing, payment, and follow-up, using electronic communications and platforms. Those contractors, however, do not have readily available tools to accurately schedule appointments with clients and/or vendors. There is a need for providing users with such tools remotely over the communications network.

### SUMMARY OF THE INVENTION

The systems, methods, and devices described herein each have several aspects, no single one of which is solely responsible for its desirable attributes. Without limiting the scope of this disclosure, one or more non-limiting features will now be described briefly.

In one embodiment, a system for calendaring an event for a first user in a calendar matrix is provided. The system comprises a hardware processor configured to authenticate a first user for accessing the calendar matrix having at least one event. The hardware processor is further configured to allow the second user to enter the event in a schedule for the first user into the calendar matrix. The system further comprises a memory device in communication with the hardware processor and configured to store the calendar matrix for later retrieval by the hardware processor. The hardware processor is further configured to adjust display dimensions of a rectangle representing the entered event in the calendar matrix based on duration of the event. The hardware processor is further configured to prohibit the second user from entering the event into the schedule if the duration of the event overlaps with a duration of another event previously entered for the first user.

In another embodiment, a method of calendaring an event for a first user in a calendar matrix is provided. The method comprises authenticating by a hardware processor a first user for accessing the calendar matrix having at least one event. The method further comprises allowing the second user to enter the event in a schedule for the first user into the calendar matrix and storing the calendar matrix for later retrieval by the hardware processor. The method further comprises adjusting display dimensions of a rectangle representing the entered event in the calendar matrix based on duration of the event. The method further comprises prohibiting the second user from entering the event into the schedule if the duration of the event overlaps with a duration of another event previously entered for the first user.

### BRIEF DESCRIPTION OF THE DRAWINGS

Embodiments of the above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale. The following drawings and the associated descriptions are provided to illustrate embodiments of the present disclosure and do not limit the scope of the claims.

FIG. 1 is a high-level block diagram of a communications system showing various network components in accordance with one embodiment of the invention.

FIG. 2 is a functional block diagram of the scheduling system of the communications network of FIG. 1.

FIG. 3 is a functional block diagram of an exemplary communications device of the communications network of FIG. 1.

FIG. 4 is a flowchart of the process of scheduling appointments in accordance with one embodiment of the invention.

FIG. 5 is a screenshot of an exemplary page showing a matrix view of appointments or events in a sample calendar matrix in accordance with embodiment of the invention.

FIG. 6 is a screenshot of an exemplary page showing sample interaction with a calendar matrix in accordance with embodiment of the invention.

### DETAILED DESCRIPTION OF THE PREFERRED EMBODIMENT

The features, aspects and advantages of the present disclosure will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

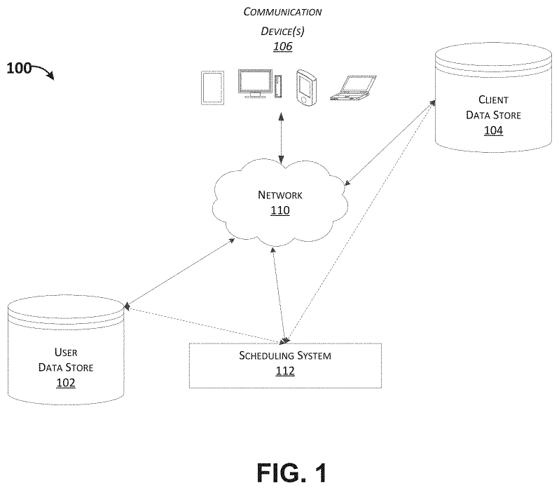

As noted above, FIG. 1 shows a high-level block diagram of a communications system 100 having various network components in accordance with one embodiment of the invention. As shown in FIG. 1, a communications network 110 connects the various network components and is shown as a network cloud that represents any wired and/or wireless network that can be used for communications between two or more communication devices. For instance, the communications network 110 may comprise the public Internet, a private network, a wired network such as a landline based data communications system, a wireless network such as a mobile data network (sometimes referred to as a “cellular” network) or Wi-Fi, or any combination of the foregoing communications networks. The network components shown in FIG. 1 include one or more user devices 106 connected to the communications network 110, a user data store 102 connected to the communications network 110, a client data store 104 connected to the communications network 110, and a scheduling system or server 112 also shown connected to the communications network 110. Each of these network components may be connected to the communications network 110 via an appropriate network connection interface that may be wired (e.g., using an Ethernet connection) and/or wireless (e.g., using a Wi-Fi or mobile data connection).

The scheduling server 112 may comprise any computer or system that provides resources, data, services, or programs to other computers, known as clients, over the communications network 110, which may include one or more web servers, mail servers, and/or file servers. As used herein, a “user” includes any person or entity that uses or subscribes to services from the scheduling system for scheduling appointments in a calendar type interface. For instance a user may be a dispatcher or scheduler of a contractor entity who performs any service to a commercial or residential client. The contractor may be an electrician, a plumber, a heating and air-conditioning worker, a painter, a carpenter, remodeler, and any other contractor who provides a service or product to a consumer client. In one embodiment, a contractor would contract or sign up for a service for a subscription fee with the operator of the scheduling server 112. The service would include providing by the operator of the scheduling server 112 a variety of contractor services to the contractor, including appointment scheduling, billing, payment, and follow-up, using electronic communications over the communications network 110. For instance, the contractor (or a “user” on behalf of the contractor entity) may enter his authentication credentials (e.g., a username and/or password) into a website or an application on his device 106 to access his profile in the scheduling server 112. Once authenticated by the scheduling server 112, the contractor can utilize the scheduling services of the scheduling server 112.

In one embodiment, the user of the communication device 106 is provided with an opportunity to create, modify, delete, or save a calendar event, such as one or more appointments with one or more clients, in a calendar matrix. The calendaring event may be saved locally in the device 106 and/or the user data store 102 under the coordination and control of the scheduling system 112. For instance, the user may view the calendar in a form of appointment squares (or any other desired shape) for each day, week, month, etc. When the user creates an appointment, the scheduling server 112 interprets each created appointment as a single square or rectangle representing a projected duration of the work, and not merely a time window of the appointment. In one embodiment, the scheduling server 112 is configured to display the appointment in a calendar format using rectangular dimensions that are proportional to the duration of the projected work for the created appointment. Hence, the time window (e.g., square or rectangle) of the appointment is not necessarily connected to the time square initially shown in the calendar matrix. The scheduling server 112 is also configured to allow the user to drag and drop an appointment to a different square, the arrival time window will not change. As an example only, the user is able to place the appointment with 8-10 am arrival window to a 5 pm timeslot. In one embodiment, the default appointment size is a 1-hour square, and the minimum appointment size is half a square for a 30-min projected work and drive time. However, any increment of time may be used for the default appointment size and/or the minimum appointment size. The maximum appointment size is the maximum amount of squares available in the calendar matrix, which theoretically can be up to 24 hours per day. After selecting an appointment square, the user is able to resize it to the desired size that is proportionate to the projected duration of the work. In one embodiment, appointments cannot overlap in time, so that each appointment occupies its unique square or rectangle within the calendar matrix.

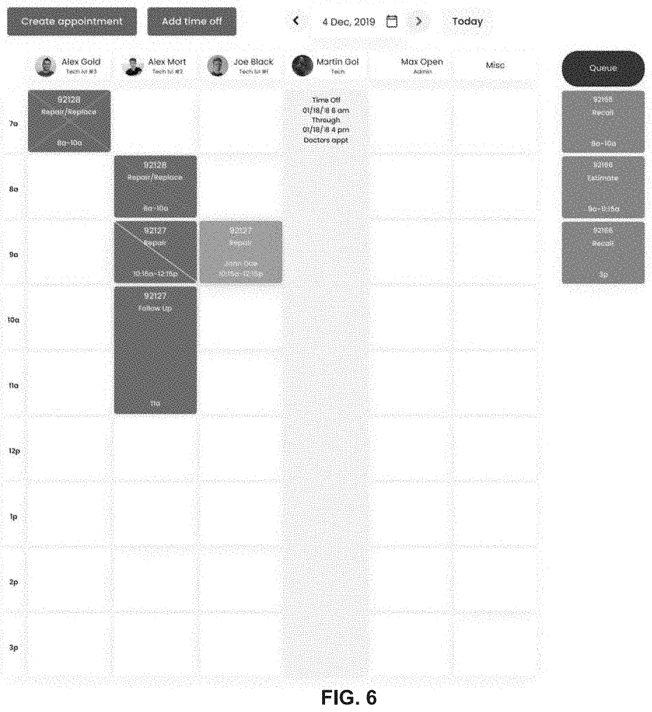

In addition to maintaining proportionality, the scheduling server 112 is configured to prohibit an overlap between two or more appointment events for the same technician. In particular, the scheduling server 112 is configured to restrict the user from entering or dropping in an event from a queue of appointments (see FIG. 6) to a technician's schedule if the schedule shows that any portion of the duration of the event overlaps with a duration of another event that was previously scheduled for the technician. Thus, the technician won't be double booked as may be the case with other scheduling systems. There are several advantages provided by the calendaring features of the scheduling server 112 described above. For instance, the calendar matrix displays actual projected work durations as indicative of the appointment itself, instead of merely a list of appointments inside of squares irrespective of time durations or based on preselected timeslots. Further, the calendaring features of the scheduling server 112 offer an emphasis on precision of the durations of the appointments to the technician. By avoiding or prohibiting an overlap in the calendar matrix between two or more appointments for the same technician, a single appointment task is ensured for each technician and for the specific duration of each appointment. Thus, the technician gets an accurate picture of her/his schedule and with precise durations for tasks without multiple appointments scheduled for the same or a portion of appointment duration.

As noted above and shown in FIG. 1, the user data store 102 communicates with the scheduling server 112 directly, or over its connection to the communications network 110, via an appropriate network connection interface that may be wired (e.g., using an Ethernet connection) and/or wireless (e.g., using a Wi-Fi or mobile data connection). The data store 102 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). In one embodiment, the data store 102 is configured to store user information, e.g., contractors or contracting companies' profiles, for processing subscription information and for authenticating users of contractors or contracting companies. The profile of such contractors or contracting companies may include contact, billing, authenticating data, and/or subscription details, which are entered by the user and/or obtained and processed by the operator of the scheduling server 112. As described above, the scheduling server 112 authenticates user(s) of user device(s) 106 based on the details stored in the user data store 102. Once user information is authenticated and subscription information is validated, the scheduling server 112 permits scheduling services to the user of the user device 106 over the network 110.

Further, as noted above and shown in FIG. 1, the client data store 104 communicates with the scheduling server 112 directly, or over its connection to the communications network 110, via an appropriate network connection interface that may be wired (e.g., using an Ethernet connection) and/or wireless (e.g., using a Wi-Fi or mobile data connection). The data store 104 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). In one embodiment, the data store 104 is configured to store client contact information that is necessary at least for scheduling appointments between the user and the client(s). As described above, the appointment information is entered into the scheduling server 112 by the contractor or user via the user device 106 over the communications network 110. The scheduling server 112 coordinates and processes the entered client information for storage in the user data store 102. and/or client data store 104 in accordance with and for each user and client profile. As indicated above, the scheduling server 112 also coordinates retrieval of such scheduling information for display to an authorized subscriber or user of the user device 106.

Although all the data stores 102 and 104 are described above as separate entities communicating with the scheduling server 112 over the communications network 110, one or more of the data stores 102 and 104 may be consolidated in a single or multiple co-located data storage device(s) for access by the scheduling server 112. Such an alternative configuration may eliminate the need for the communications network 110 to support communication between the data stores 102/104 and the scheduling server 112. Without the communications network 110, the scheduling server 112 communicates with and maintains control of the data stores 102/104 directly, i.e., via a direct communication link. In summary, the scheduling server 112 coordinates access and exchange of information between the user device(s) 106 and the data stores 102 and 104.

Finally, as noted above and shown in FIG. 1, the user device(s) 106 communicates with the scheduling server 112 over its connection to the communications network 110 via an appropriate network connection interface that may be wired (e.g., using an Ethernet connection) and/or wireless (e.g., using a Wi-Fi or mobile data connection). Each user device(s) 106 may comprise any type of mobile or stationary communications device, such as a desktop or laptop personal computer or terminal, a tablet device, a personal data assistant (PDA), a mobile (smart) phone, a kiosk, a smart watch, a car console, a media player, or any other device configured to communicate over the communications network 110 via a wired and/or wireless connection. In one embodiment, the user device(s) 106 is configured with a user interface medium, such as an installed web browser or a dedicated application, which permits access to the scheduling server 112 via the communications network 110. As described above, a “user” on behalf of the user may enter his authentication credentials (e.g., a username and/or password) into the user interface medium on the device 106 to access his profile in the scheduling server 112. Once authenticated by the scheduling server 112, the user can access his user's own profile in the user data store 102 and/or client information in the client data store 104, in accordance with the conditions described respectively above. In one embodiment, the client schedule or appointments may be obtained from another independent calendaring source as authorized by the user and/or client. The scheduling server 112 coordinates and processes the entered client information for storage in the data store 104 in accordance with a particular client profile. The scheduling server 112 also coordinates retrieval of such client information for display to the user of the user device 106. It is worth noting that many of the functions of the scheduling server 112 described herein may reside elsewhere in the communications network 100. For instance, such scheduling functions may be embedded in the user device 106 and/or elsewhere in a cloud-based system.

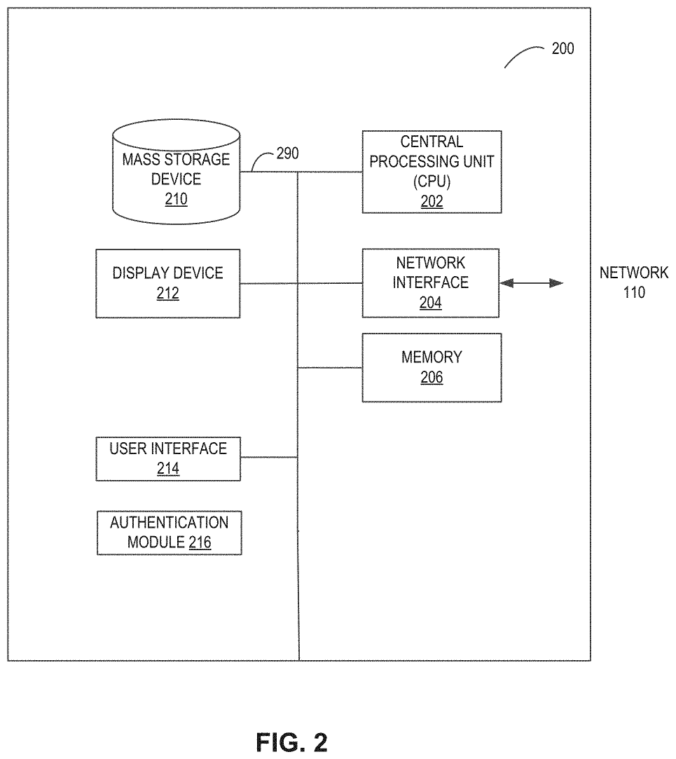

As noted above, FIG. 2 is a functional block diagram of the scheduling system 112 of the communications network 100 of FIG. 1. Generally, the scheduling server 112 may comprise any computer or system that provides resources, data, services, or programs to other computers, known as clients, over the communications network 110, which may include one or more web servers, mail servers, and/or file servers. In one embodiment, and with reference to FIG. 2, the scheduling server 112 comprises a central processing unit (CPU) 202 connected to a physical bus network 220, to which the following physical components/devices are connected: a mass storage device 210, a display device 212, a user interface 214, an authentication module 216, a memory unit 206, and a network interface 204. The CPU 202 may be built into a computer that is IBM, Macintosh, or Linux/Unix model or compatible type, or into a server or workstation or a mobile computing device operating on a suitable operating system. The CPU 202 may control and coordinate operation of all of the foregoing components/devices within the scheduling server 112. The CPU 202 may also be referred to as a “processor” or “CPU”, which may comprise or be a component of a processing system implemented with one or more processors. The one or more processors may be implemented with any combination of general-purpose microprocessors, microcontrollers, digital signal processors (“DSPs”), field programmable gate array (“FPGAs”), programmable logic devices (“PLDs”), controllers, state machines, gated logic, discrete hardware components, dedicated hardware finite state machines, or any other suitable entities that can perform calculations or other manipulations of information.

As shown in FIG. 2, the mass storage device 210 and memory unit 206 are two types of storage components that may be found in the scheduling sever 112. The memory unit 206 includes one or both of read-only memory (ROM) and random access memory (“RAM”) and may provide instructions and data to the processor 202. For example, data received via inputs received over the communications network 110 by one or more components of the scheduling server 112 may be stored in the memory unit 206. A portion of the memory 206 may also include non-volatile random access memory (“NVRAM”). The processor 202 typically performs logical and arithmetic operations based on program instructions stored within the memory 206 in order to perform and achieve the various functions described in connection with the scheduling server 112 of FIG. 1 above. The instructions in the memory 206 may be executable to implement the functions of the scheduling server 112. In some embodiments, the memory 206 may be configured as a database and may store information that is received via the network interface 204 or the user interface 214.

On the other hand, the mass storage device 210 provides the scheduling server 112 with larger storage capacity (compared to the memory unit 206) to accommodate storage for large files and a more permanent storage medium. The mass storage device 210 may also be used to back up all data received or stored in the memory unit 206. The data store 210 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). The mass storage device 210 may store software or machine instructions for allowing the CPU to process many of the subscriptions, authentication, and calendaring information described in connection with FIG. 1 above. Software generally refers to any type of instructions, whether referred to as software, firmware, middleware, microcode, hardware description language, or otherwise. Instructions may include code (for example, in source code format, binary code format, executable code format, or any other suitable format of code). The instructions, when executed by the one or more processors, cause the processing system to perform the various functions described herein. Accordingly, the scheduling server 112 includes, for example, hardware and firmware and/or software, or any combination thereof.

The user interface 214 may comprise a keypad, a microphone, a touchpad, a speaker, and/or a touch display, or any other commonly available input/output (“I/O”) devices and interfaces. The user interface 214 may include any element or component that conveys information from the operator of the scheduling server 112 to the scheduling server 112. In one embodiment, the display device 212 may be combined with or be separate from the user interface 214 and may include one or more display devices, such as a monitor, that allows the visual presentation of data to the operator of the scheduling server 112. More particularly, the display device provides for the presentation of GUIs, application software data, websites, web apps, and multimedia presentations, for example.

The network interface 204 provides a communication interface to various external devices directly or over the communications network 110. For example, the scheduling server 112 is electronically coupled to the communications network 110 (FIG. 2A), which comprises one or more of a LAN, WAN, and/or the Internet. Accordingly, the network interface 204 includes an interface allowing for communication with the communications network 110, for example, via a wired communication port such as Ethernet, telephone connection, cable television or wired internet access, and/or fiber-optic communication, a wireless communication port, or a combination of both.

In one embodiment, the authentication module 216 comprises a dedicated processor or may be combined within the CPU 202. As described in connection with FIG. 1 above, the authentication module 216 performs the authentication functions of subscriber users who sign up (or already signed up) for accessing and receiving the services offered by the scheduling server 112. For example, the contractor (or a “user” on behalf of the contractor entity) may enter his authentication credentials (e.g., a username and/or password) into a website or an application on his device 106 to access his profile in the scheduling server 112. The authentication module 216 authenticates the entered credentials and, if the credentials pass, the contractor can create, update, or delete a calendar event as described in connection with FIG. 1 above.

As noted above, communications between the various components or devices within the scheduling server 112 are exchanged over the bus network 220. The bus network 220 may include a data bus, for example, as well as a power bus, a control signal bus, and a status signal bus in addition to the data bus. The bus network 220 may be implemented in Peripheral Component Interconnect (“PCI”), Microchannel, Small Computer System Interface (“SCSI”), Industrial Standard Architecture (“ISA”), and/or Extended ISA (“EISA”) architectures, for example. Finally, the functionality provided in the components and devices of the scheduling server 112 may be combined into fewer components and devices or further separated into additional components and modules than that shown in FIG. 2.

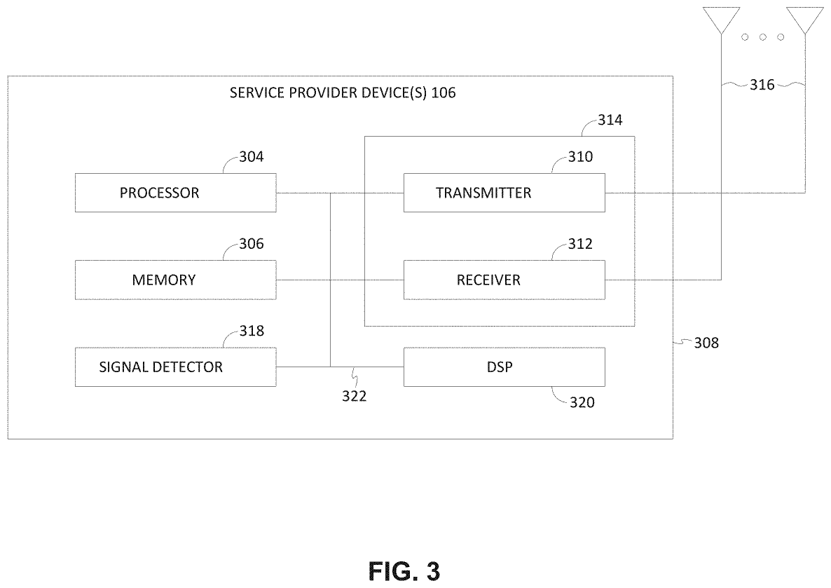

FIG. 3 is a functional block diagram of an exemplary user device 106 of the communications network 110 of FIG. 1. The user device 106 is an example of a device that may be configured to implement the functions described in connection with the interaction of the user (on behalf of the contractor entity) with the scheduling server 112 described in connection with FIG. 1 above. The user device 106 may comprise a processor 304 which controls operation of the user device 106. In addition to the processor 304, the user device 106 comprises a memory 306, which may include both read-only memory (ROM) and random access memory (RAM), provides instructions and data to the processor 304. A portion of the memory 306 may also include non-volatile random access memory (NVRAM), The processor 304 may perform logical and arithmetic operations based on program instructions stored within the memory 306. The instructions in the memory 306 may be executable to implement the functions of the user device 106 described above. As shown in FIG. 3, the processor 304 and memory 306 are connected to a physical bus system 322 (similar in function and structure to the bus system 220 of FIG. 2) to exchange communication messages and instructions. The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The user device 106 may also comprise a housing 308 that may include a transmitter 310 and a receiver 312 to provide respective transmission and reception of data between the user device 106 and the scheduling server 112 over the communications network 110. The transmitter 310 and receiver 312 may be combined into a transceiver 314. A single or a plurality of transceiver antennas 316 may be attached to or integrated within the housing 308 and electrically coupled to the transceiver 314. The antennas 316 are provided to allow communications over a wireless medium, such as those accommodating data communication, including Wi-Fi and/or cellular data channels. In an embodiment where the user device 106 interfaces with the communications network 110 over a wired medium, the antennas 316 would be replaced with or added to a wired interface such as Ethernet, telephone connection, cable television or wired internet access, and/or fiber-optic communication. The user device 106 may also comprise multiple transmitters, multiple receivers, and multiple transceivers (not shown in this figure) to accommodate compatible communications with the communications network 110 and other devices (not shown in this figure). As shown in FIG. 3, each of the transmitter 310 and receiver 312 is connected to the bus system 322 to exchange messages and data with the processor 304, memory 306, and other components within the user device 106.

The user device 106 may also comprise a signal detector 318 that may be used to detect and quantify the level of signals received by the receiver 312. The signal detector 318 may detect such signals as total energy, energy per subcarrier per symbol, power spectral density and other signals. The user device 106 may also include a digital signal processor (DSP) 320 for use in processing incoming and outgoing communication signals, e.g., to confirm the communication signals to suitable or compliant communication protocols. The signal detector 318 may determine if the received signals are of sufficient strength for processing by the DSP 320.

The various components of the wireless communication device 302 may be coupled together by the bus system 322, which may include a power bus, a control signal bus, and a status signal bus in addition to a data bus.

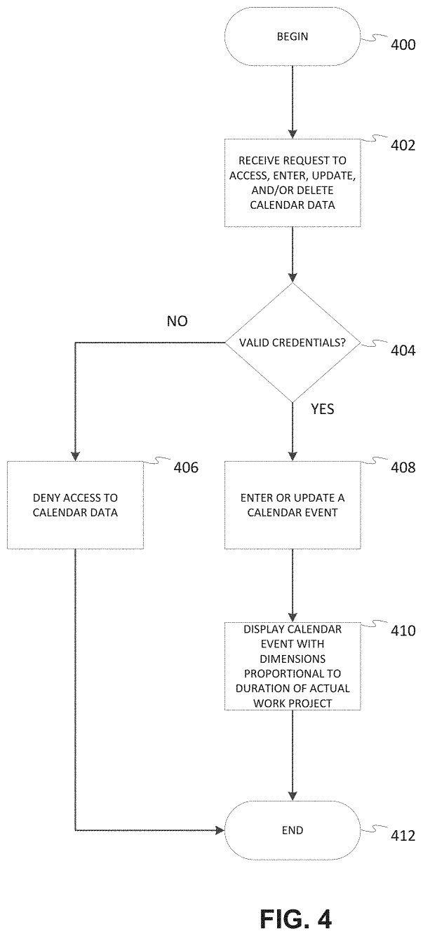

As noted above, FIG. 4 is a flowchart of the process of scheduling appointments in accordance with one embodiment of the invention. The process begins at block 400. At block 402, the scheduling server 112 receives a login request for authentication of a user of a user device 106. As described above, a “user” on behalf of the contractor entity may enter his authentication credentials a username and/or password) into a website or an application on his device 106 to access his profile in the scheduling server 112. As described in connection with FIG. 1 above, the user typically logs in to access, enter a new, update an existing, and/or delete a calendar event. If at decision block 404 the scheduling server 112 fails to validate the authentication credentials of the user, the scheduling server 112 would (at block 406) deny access to the calendar data. If at the decision block 404 the scheduling server validates the authentication credentials of the user, the scheduling server 112 would (at block 408) grant access to the calendar data store 104. Once authenticated by the scheduling server 112, the scheduling server 112 grants the user with access at block 408 to access a calendar as noted above. The user may enter a new or update an existing (e.g., previously saved) calendar event into a calendar matrix as described above. As described above, the scheduling server 112 adjusts the display of the calendar rectangle to have dimensions that are commensurate with or proportional to the duration of the actual work project at block 410, irrespective of the blocks of time initially displayed in the calendar matrix. The process ends at block 412.

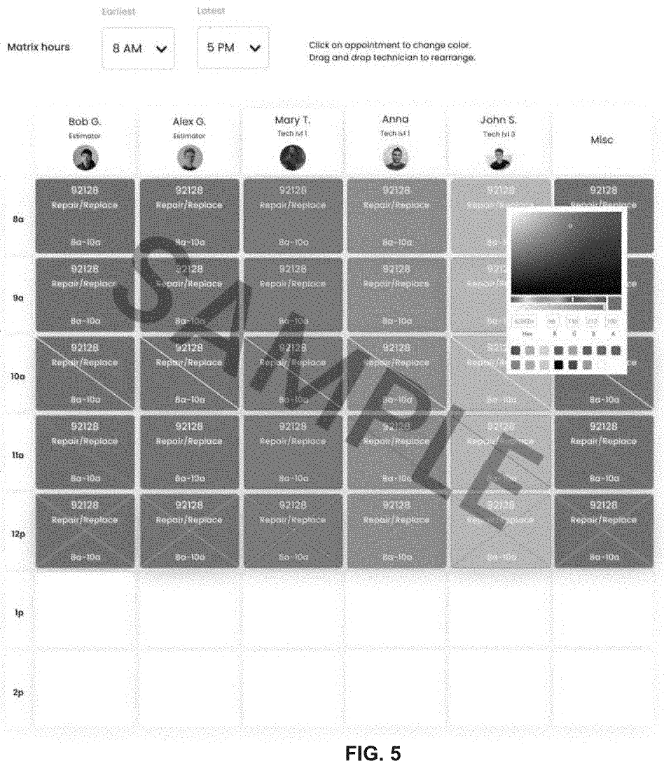

FIG. 5 is a screenshot of an exemplary page showing a matrix view of appointments or events in a sample calendar. In this example, the page shown in FIG. 5 allows the user (e.g., dispatcher or scheduler) to set up the calendar matrix view with the time shown along the Y axis and names of appointment actor (e.g., technician name) along the X axis. The calendar matrix can be displayed in this format or rotated with so that the user names shown along the Y axis and time along the X axis. As shown in FIG. 5, the user is able to select the first hour and latest hour to display on the matrix using drop down menus in the top left corner of the page. The user is also able to drag and drop the user column to rearrange order of the technicians. Other information such as full name title of the user are shown. Also, a distinct color coding can be used for each user in the user row (X axis) that can be changed by the user to suit a desired taste. For instance, the user can change the color of the squares of the user (entire column) by clicking on the square in the column. The user is also able to drop his/her appointments in that column to keep appointments that do not belong to any other users.

FIG. 6 is a screenshot of an exemplary page showing sample interaction with a calendar matrix in accordance with one embodiment of the invention. In this example, a calendar matrix having a time along the Y axis and users along the X axis are shown in a manner similar to those shown in FIG. 5. If a technician is clocked out or off for the times shown in the matrix view, the color shading is changed to display as a grey color indicating “clocked out time” as demonstrated by user column for “Martin Gol”. Users are able to drag and drop appointments on the matrix to different time slots, technicians, miscellaneous or queue columns. In one embodiment, if the technician is off or his/her schedule is blocked off, then the user (e.g., dispatcher or scheduler) of the calendar cannot drop or enter an event appointment in the technician's calendar matrix because the technician is off or unavailable. This offers the advantage of scheduling an event to a technician who is available to do the work for the appointment.

Users are able to click on any appointment to open the modal window with an appointment view/edit. As described in connection with FIG. 1, the scheduling server 112 displays an appointment square or rectangle to represent actual projected work time and not merely the time window of the appointment. In particular, the scheduling server 112 is configured to display the dimension (e.g., vertical dimension in this instant) of the rectangle block of the appointment to represent the proportional duration (along the Y axis) of the projected work. A time window of the appointment showing the appointment within that window, and nothing more, does not reflect the actual duration of time for the projected work itself. Thus, it is advantageous to list the events in the calendar matrix as a function of the duration of the projected work. The time window of the appointment is not necessarily connected to the time square block in the matrix calendar. In one embodiment, the user can drag and drop an appointment to a different square, and the arrival time window will not change. For instance, the user is able to place appointment with 8-10 am arrival window and up to the 5 pm slot. As noted above, and as an example only, the user is able to place the appointment with 8-10 am arrival window to a 5 pm timeslot. In one embodiment, the default appointment size is a 1-hour square, and the minimum appointment size is half a square for a 30-min projected work and drive time. However, any increment of time may be used for the default appointment size and/or the minimum appointment size. The maximum appointment size is the maximum amount of squares available in the calendar matrix, which theoretically can be up to 24 hours per day. After selecting an appointment square, the user is able to resize it to the desired size that is proportionate to the projected duration of the work. In one embodiment, appointments cannot overlap in time, so that each appointment occupies its unique square or rectangle within the calendar matrix.

Further, as shown in the top left corner of the page, FIG. 6 shows a “Create appointment” virtual button, which opens new modal window to create new appointment when clicked by the user. In addition, an “Add Time Off” virtual button is shown to the right of the “create appointment” button, which is when clicked by the user shows a modal window with selection of the User, Start date, end date, start time, end time and the reason for time off. As shown in the top of the page, the user can click a forward or backward arrow to advance the display of the calendar to the next or previous day, respectively. To the right of the forward arrow, the “Today” virtual button shows today's calendar when clicked. In the top right corner of the page, FIG. 6 shows a “Queue” heading for a column of newly created appointments. In one embodiment, the Queue column offers as a temporary holding column for one or more appointments requested by customer(s) over the communications network 110 and/or to be scheduled by the user. While in the Queue column, the appointment event is not yet assigned to a technician, time or date. For such appointments in the Queue, the user scheduling server provides the user with the ability to move or drop the appointment from the Queue column into a desired (and available) time slot for a technician. As noted above, if the technician is off or the desired timeslot is unavailable, the user would not be able to move or drop the appointment from the Queue column to the desired timeslot or technician. The content of this column will not change if the user moves the calendar to display a different day. In one embodiment, the content of this Queue column is always present, so a user can pick an appointment from the Queue column and drop into a specific day for a desired technician. The technician in turn will access the same or a similar calendar matrix on her/his own device((that is similar to the user device 106 of FIG. 1) to view his schedule and details of each appointment, e.g., address, description of the work, special instructions, etc. Typically, the technician's ability to modify the calendar matrix is prohibited or limited. In one embodiment, the user may allow a technician with the ability to do further actions with the calendar matrix. The scheduling server 112 offers the user with a menu (not shown in this figure) to select or deselect functions that the technician is allowed to do within the calendar matrix.

As describe in connection with FIG. 1 above, the scheduling server 112 is configured to prohibit an overlap between two or more appointment events for the same technician. In particular, the scheduling server 112 is configured to restrict the user from entering or dropping in an event from Queue column to a technician's schedule if the schedule shows that any portion of the duration of the event overlaps with a duration of another event that was previously scheduled for the technician. Thus, the technician won't be double-booked in the same duration of time as may be the case with other scheduling systems. As also described above, the calendar matrix displays actual projected work durations as indicative of the appointment itself, instead of merely a list of appointments inside of squares irrespective of time durations or based on preselected timeslots. Further, the calendaring features of the scheduling server 112 offer an emphasis on precision of the durations of the appointments to the technician. By avoiding or prohibiting an overlap in the calendar matrix between two or more appointments for the same technician, a single appointment task is ensured for each technician and for the specific duration of each appointment. Thus, the technician gets an accurate picture of her/his schedule and with precise durations for tasks without multiple appointments scheduled for the same or a portion of appointment duration.

As further shown in FIG. 6, if the appointment status is “In progress” then the user will see a white diagonal line in the appointment square or box as demonstrated in the 9 am appointment box for Alex Mort. If the appointment status is “Completed”, then the user will see a green diagonal line in the appointment box. In one embodiment, the appointment squares display other related information, such as zip code of the appointment property, type of the appointment, preferred technician (if any) and projected time window of the appointment in the appointment box itself. If the appointment status is “Canceled”, then the user will see a red cross (e.g., two red diagonal lines) in the appointment box, as demonstrated by the 7 am appointment box for user Alex Gold. If the appointment has Preferred Technician selected, then there a red outline around the appointment is shown, as demonstrated by the 9 am appointment box for user Joe Black.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

The various illustrative logical blocks, modules, and algorithm elements described in connection with the embodiments disclosed herein (e.g., in FIGS. 1-4) can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein, e.g., functional block diagrams in FIGS. 1-5 above, can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable devices that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some, or all, of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or blocks. Thus, such conditional language is not generally intended to imply that features, elements and/or blocks are in any way required for one or more embodiments or that one or more embodiments necessarily include logic for deciding, with or without user input or prompting, whether these features, elements and/or blocks are included or are to be performed in any particular embodiment.

Disjunctive language such as the phrase “at least one of X, Y, or Z,” unless specifically stated otherwise, is otherwise understood with the context as used in general to present that an item, term, and so forth, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following.

What is claimed is:

1. A system for calendaring an event for a first user in a calendar matrix, the system comprising:
a hardware processor configured to authenticate a first user for accessing the calendar matrix having at least one event, and configured to allow the second user to enter the event in a schedule for the first user into the calendar matrix; and
a memory device in communication with the hardware processor and configured to store the calendar matrix for later retrieval by the hardware processor, wherein the hardware processor is further configured to adjust display dimensions of a rectangle representing the entered event in the calendar matrix based on duration of the event and configured to prohibit the second user from entering the event into the schedule if the duration of the event overlaps with a duration of another event previously entered for the first user.

2. The system of claim 1, wherein the hardware processor obtains the event entered by the second user over a communications network that comprises a wired and/or wireless network.

3. The system of claim 1, wherein the hardware processor is further configured to determine if the duration of the event is currently in progress and, if so, display to the first user the event with a color indicative that the event is in progress.

4. The system of claim 1, wherein the hardware processor is further configured to determine if the duration of the event has passed and, if so, display to the first user the event with a color indicative that the event is completed.

5. The system of claim 1, wherein the hardware processor is further configured to determine identity of the user and assign a unique color for events entered from the first user that is different from a color assigned to events entered by the second user for another user.

6. The system of claim 1, wherein the hardware processor is further configured to receive a cancellation request of the event from a client device over a communications network, and configured to display to the first user the event with a color indicative that the event is canceled.

7. The system of claim 6, wherein the hardware processor is configured to prompt at least one of the first and second users to confirm and/or respond to the cancellation request of the client.

8. The system of claim 1, wherein the memory device comprises a first data storage device for storing information about the first and second users and a second data storage device for storing information about one or more clients for which the event is entered.

9. The system of claim 1, wherein the hardware processor comprises a web server configured to interact with the first and second users via a web or dedicated application installed in a communications device accessible by the first and second users, respectively.

10. The system of claim 1, wherein the hardware processor is configured allow the second user to create or enter an event in a queue that is displayed to the second user for moving the event in the queue to the schedule of the first or another user.

11. The system of claim 10, wherein the hardware processor is configured to prohibit the second user from moving the event in the queue to the schedule of the first user if the event overlaps with another event already calendared in the schedule of the first user or if the first user is unavailable for the duration or on the day of the schedule of the first user.

12. A method of calendaring an event for a first user in a calendar matrix, the method comprising:
authenticating by a hardware processor a first user for accessing the calendar matrix having at least one event;
allowing the second user to enter the event in a schedule for the first user into the calendar matrix;
storing the calendar matrix for later retrieval by the hardware processor;
adjusting display dimensions of a rectangle representing the entered event in the calendar matrix based on duration of the event; and
prohibiting the second user from entering the event into the schedule if the duration of the event overlaps with a duration of another event previously entered for the first user.

13. The method of claim 12, further comprising allowing the second user to create or enter an event in a queue that is displayed to the second user for moving the event in the queue to the schedule of the first or another user.

14. The method of claim 13, further comprising prohibiting the second user from moving the event in the queue to the schedule of the first user if the event overlaps with another event already calendared in the schedule of the first user or if the first user is unavailable for the duration or on the day of the schedule of the first user.
